(19) United States
(12) Patent Application Publication
(10) Pub. No.: US 2022/0026959 A1
(43) Pub. Date: Jan. 27, 2022

(54) ELECTRONIC DEVICES WITH HINGE ASSEMBLIES

(71) Applicant: Hewlett-Packard Development Company, L.P., Spring, TX (US)

(72) Inventor: Hyunmin Moon, Spring, TX (US)

(73) Assignee: Hewlett-Packard Development Company, L.P., Spring, TX (US)

(21) Appl. No.: 17/293,023

(22) PCT Filed: Apr. 18, 2019
(86) PCT No.: PCT/US2019/028097

§ 371 Date: May 11, 2021

(51) Int. Cl. G06F 1/16

(52) U.S. Cl. CPC G06F 1/1681; G06F 1/1647; G06F 1/1616

(57) ABSTRACT

Present examples relate to an electronic device with a hinge assembly. The hinge assembly allows for controlled opening and closing, allows for a spacing between housing in a closed configuration for placement of a peripheral device, and, in an open position, provides a closely spaced arrangement of the housings, with a smaller space or gap than in the closed position.

### BACKGROUND

Many devices rely on hinges to facilitate rotational motion of one element or body relative to another. For example, a hinged device and a first component or body may rotate relative to a second component or body while being mechanically coupled thereto.

A hinge assembly for such an electronic device may allow the device to close in order to transport from place to place. Further, however, the hinge assembly allows one portion of the device to open relative to the other for use of the electronic device.

### BRIEF DESCRIPTION OF THE DRAWINGS

Some examples of the present application are described with respect to the following figures:

FIG. 1 is a perspective view of an example electronic device in a closed position;

FIG. 2 is a perspective view of an example electronic device in an open position;

FIG. 3 is an exploded schematic view of the example electronic device with hinge assembly;

FIG. 4 is a side elevation view of the example electronic device in the closed position;

FIG. 5 is a side sequence view of the movement of a housing and the hinge assembly; and,

FIG. 6 is a cross sectional view of the electronic device in an open position.

### DETAILED DESCRIPTION

Some electronic devices may include a removable peripheral, such as a keyboard. When such electronic device is a mobile device, there may be a need to easily transport the removable peripheral. The electronic device may include a peripheral retention placement or position. When the peripheral is removed during use, that removal may expose a gap or spacing associated with the peripheral retention placement or position that interferes with or otherwise diminishes use of the electronic device.

An electronic device with hinge assembly is provided but is not limited in its application to the details of construction and the arrangement of components set forth in the following description or illustrated in the drawings. The described examples are capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

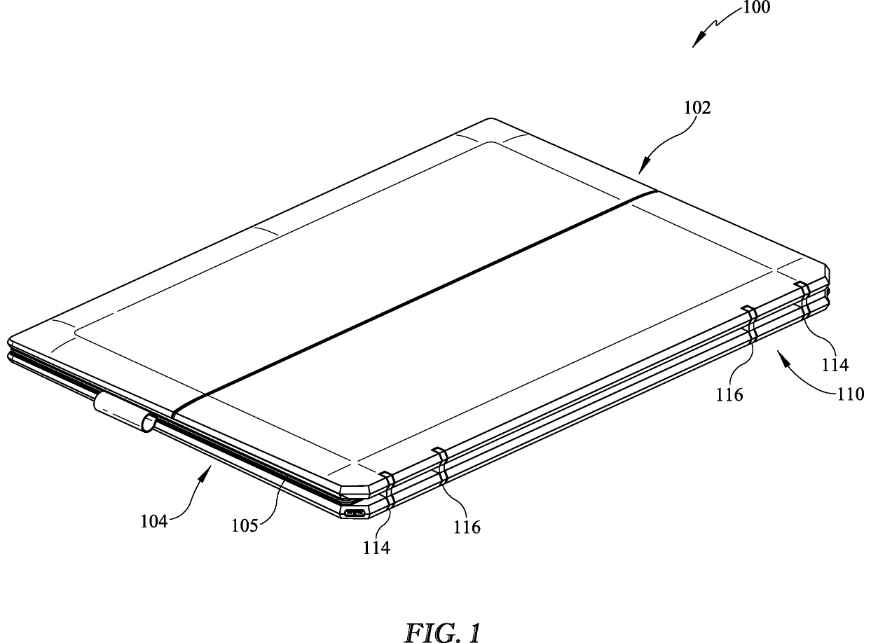

Referring now to FIGS. 1-6, present examples relate to an electronic device with a hinge assembly. The hinge assembly allows for controlled opening and closing, allows for a spacing between housing in a closed configuration for placement of a peripheral device, and, in an open position, provides a closely spaced arrangement of the housings, with a smaller space or gap than in the closed position. In some examples, an electronic device may comprise a first housing having a first display therein. A second housing positioned adjacent to the first housing, and having a second display in the second housing. A hinge assembly is to connect the first housing and the second housing and may comprise a link extending between the first housing and the second housing. A first shaft disposed in the first housing, a second shaft disposed in the second housing and a gear assembly disposed in the link having a first gear connected to the first shaft and a second gear connected to the second shaft. A first distance may be defined in a direction of the link between a first surface of the first housing and a second surface of the second housing when the first housing and the second housing are in a first configuration. A second distance may be defined in a direction of the link between the first housing and the second housing when the first housing and the second housing are in a second configuration. The first distance may be larger than the second distance. In some examples, the first shaft is to rotate and translate relative to the second shaft during a movement of the first housing, the second housing, or a combination thereof.

Hinges may be used on electronic devices. For example, laptop computers, notebooks, and ultrabooks, may utilize hinges to provide motion between a housing having a display and a housing a keyboard and other associated electrical computing components. Some hinges may allow motion from 0 to 360 degrees so that the laptop may be closed or may be used in a standard laptop mode, or may be rotated about 360 degrees so that the computing device may also be used in a tablet mode. Thus, hinges may provide various options for use of the electronic device.

Referring now to FIG. 1, an example perspective view of an electronic device 100 is depicted, examples of which may include, but are not limited to, computers, laptop computers, personal digital assistants, tablets, smart phones, mobile devices, gaming systems, among other such electronic devices or components, or combinations of any of the preceding. The term “electronic device” may mean a device performing a particular function according to, for example, machine-readable instructions, such as a home appliance, an electronic scheduler, a portable multimedia player, a mobile communication terminal, a tablet PC, a video and/or sound device, a desktop PC or laptop computer, a navigation for automobile, etc. In some examples, the electronic device 100 may be a pair of hingedly connected displays which may be opened to provide a dual display arrangement or may be closed for travel and/or storage. The present examples provide a hinge assembly 110 for such electronic device 100 that includes multiple hinging elements. In some examples, the hinged portions of the electronic device may move independently, or alternatively may be synchronized.

The depicted electronic device 100 may include a first housing 102 and a second housing 104. The two housings 102, 104 may be connected by a hinge assembly 110 disposed at adjacent edges of the housings 102, 104. The hinge assembly 110 may provide pivoting motion of each of the housings 102, 104. The hinge assembly 110 may include components on either of both of the inside and outside of the housings 102, 104. The hinge assembly 110 may provide a space between the two housings 102, 104 when in the closed position, for placement of a removable peripheral, for non-limiting example, a keyboard 105. The housings 102, 104 may be opened via the hinge assembly 110 to use the display functionality of the two housings 102, 104 or provide other functionality of the electronic device 100.

The hinge assembly 110 may include a plurality of links 114, 116, along the adjacent edges of the housings 102, 104 which allow for movement of the housings 102, 104 between the closed position depicted and an open position. The hinge assembly 110 allows for movement of one housing relative to another for any of various distances up to about 360 degrees.

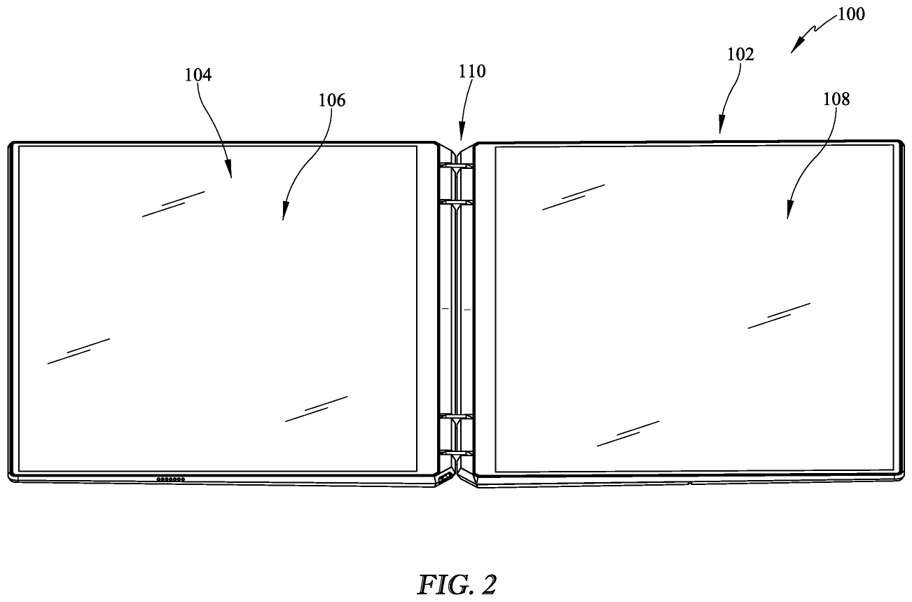

Referring now to FIG. 2, an example second perspective view of the electronic device 100 is depicted in the open position. In this view, the housings 102, 104 are shown hinged to about 180 degrees from the closed position of FIG. 1. The hinge assembly 110 allows pivoting motion for each housing 102, 104 relative to the links 114, 116, respectively. In this open configuration however, the space between the housings 102, 104 is decreased as compared to the closed position of FIG. 1.

The links 114, 116 may be of various shapes. In some examples, the ends of the links 114, 116 may be shaped to approximate the edges of the housings 102, 104, wherein the links are positioned. With additional reference to FIG. 1, the ends of the links 114, 116 are defined by linear segments which approximate the side profile of the housings 102, 104. This provides a matching appearance along the rear edge of the electronic device 100, when it is closed. The links 114, 116 may be of other shapes however, and in some examples may be hollow as will be described further herein.

In the depicted example, each housing 102, 104 comprises a display 108, 106, respectively. The displays 106, 108 allow a user of the electronic device 100 to interact with and implement the functionality of the electronic device 100. The displays 106, 108 may be of various non-limiting types. For example, the displays 106, 108 may be liquid crystal display (LCD), light-emitting diode (LED), organic light-emitting diode (OLED), and/or quantum-dot light emitting diode (QLED) displays. This list is not exhaustive and other display types may be utilized.

By minimizing the spacing between the housings 102, 104, the gap between the displays 106, 108 is reduced and is less visually distractive to the user. In the depicted example, the displays 106, 108 are shown arranged in a landscape orientation, but alternatively may also be used in a portrait orientation with the electronic device 100 rotated 90 degrees from the orientation depicted. A variety of supports may be used to position the housings 102, 104 at a desired angle.

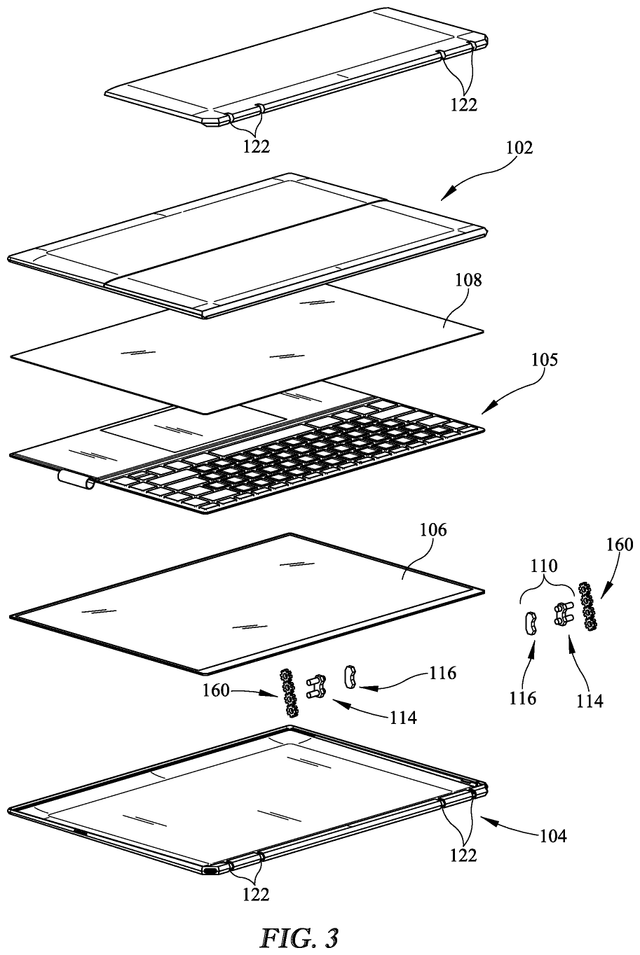

Referring now to FIG. 3, an example exploded schematic perspective view of the electronic device 100 is depicted wherein the housings 102, 104 are exploded from the hinge assembly 110. At the bottom of the perspective view, the housing 104 is shown generically and the corresponding display 106 is shown above. Similarly, above keyboard 105, the housing 102 is shown with a display 108 represented. Components within the housings 102, 104 may vary depending on the function of the electronic device 100. In a non-limiting example with the two displays, display components such as a video processor and/or video memory may be disposed in the housings 102, 104 behind the displays 106, 108. Other processing and/or communication hardware may also be utilized in either or both of the housings 102, 104.

Connecting the housings 102, 104 is the hinge assembly 110. The hinge assembly 110 comprises the hinge links 114, 116, wherein the link 114 may include a gear assembly 160 to add friction or torque requirement to the movement of one housing relative to the other. The gear assembly 160 may also synchronize the movement of the housings 102, 104. More specifically, the housing 102 may pivot relative to the adjacent ends of the links 114, 116, and the housing 104 may pivot relative to the adjacent ends of the links 114, 116.

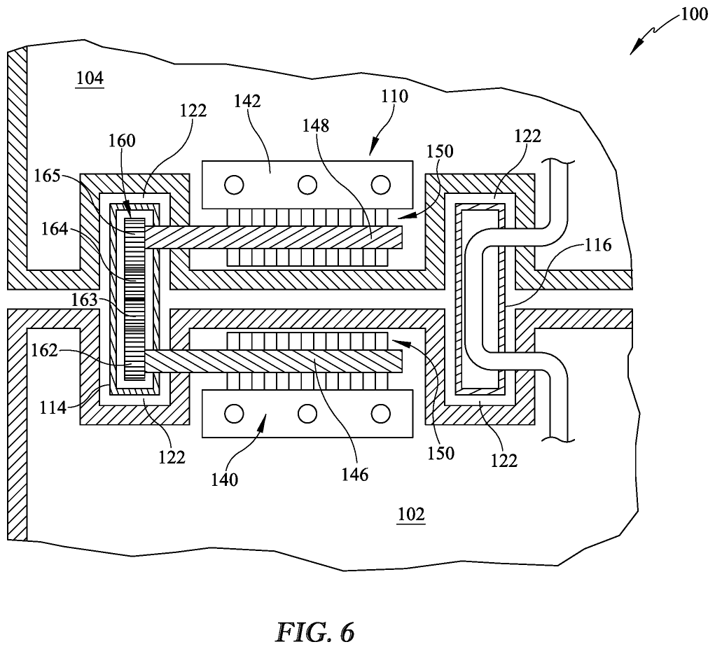

Further, each of the housings 102, 104 may include a plurality of housing gaps 122 which may receive or otherwise locate the links 114, 116. As will be described further, the hinge assembly 110 comprises shafts 146, 148 (FIG. 6) which pivotally connect the housings 102, 104. The housing gaps 122 may be sized to allow pivoting of the links 114, 116 relative to the housings 102, 104.

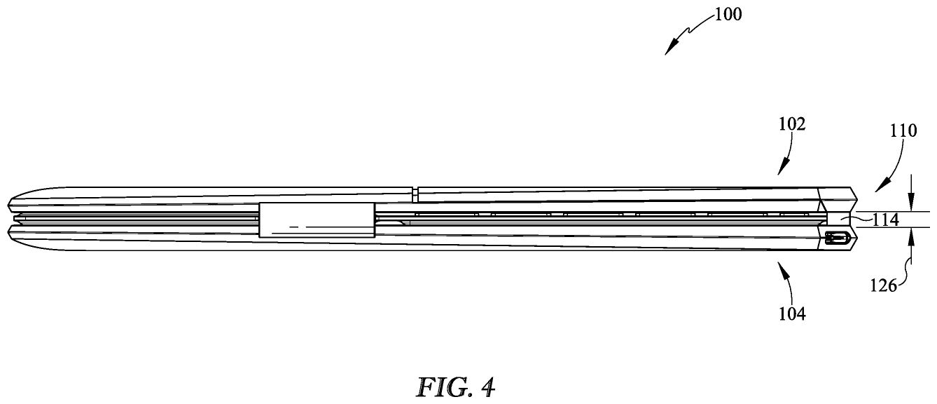

With regard now to FIG. 4, a side view of the electronic device 100 is shown, wherein the housings 102, 104 are in a closed position. The removable keyboard 105 is disposed between the housings 102, 104. The positioning of the keyboard 105 between the housings 102, 104 is made possible, in part, by the lengths of the links 114, 116 (FIG. 1) which spaces apart the housings 102, 104.

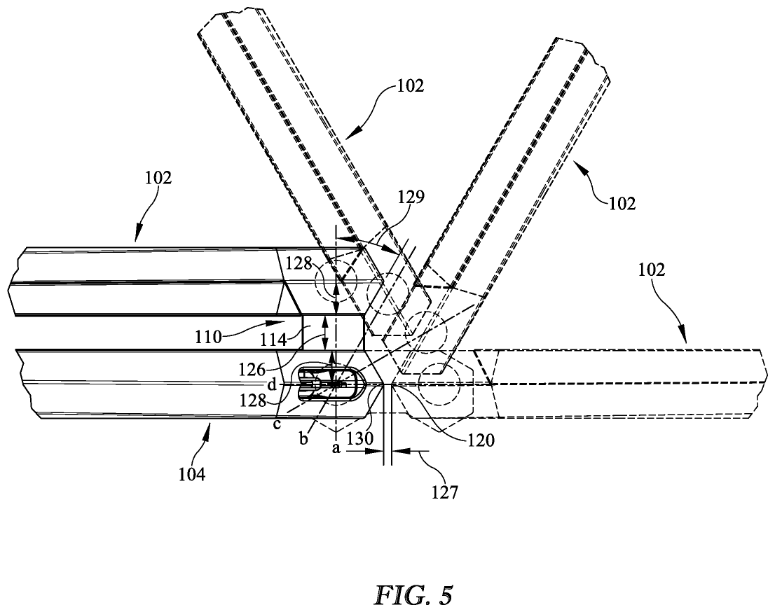

The view of the hinge assembly 110 is shown with an improved view of the link 114 extending between the housings 102, 104. This space or spacing 126 between the housings 102, 104 allows for positioning of the removable keyboard 105 in the closed configuration. The space 126 is measured between opposed surfaces of the housings 102, 104, which may include, but is not limited to, surfaces of the opposed displays. However, as previously described, the spacing between the housings 102, 104 may decrease when in the open position in order to reduce visual distraction between the displays 106, 108. More specifically, during opening movement from zero to about one hundred eighty degrees, the spacing 126 changes to the spacing 127 (FIG. 5) so that the distance between the housings 102, 104 decrease. If the hinge continues movement from about 181 degrees to about 360, the spacing between the housings 102, 104 increases again.

With reference now to FIG. 5, a side sequence view of the electronic device 100 is provided. The housings 102, 104 are initially shown in a closed position in solid lines and are shown also in various sequential movements to an open position at about 180 degrees from the closed position. In the initial position, indicated as position a, the spacing 126 (FIG. 4) is shown generally between the adjacent surfaces of the housings 102, 104. Further, the link 114 is generally oriented in a vertical position. The subsequent sequential movements are shown in broken line and indicated as positions b, c, d.

Next in the sequence, position b, the housing 102 is shown pivoted relative to the visible link 114. This occurs as at least one of the housings 102, 104 pivots relative to the links 114, 116. The link 114 is also shown pivoted relative to the housing 104 and is angled relative to its vertical position of the first sequence, closed position.

Referring to the third sequence position c, the housing 102 is further pivoted relative to the link 114. Likewise the link 114 is further pivoted relative to the housing 104.

In the closed position a, a longitudinal axis of the link 114 is disposed at about 90 degrees to the longitudinal axis of the housing 102, generally extending along the side of the housing 102. In the two sequence positions b, c between the closed position and the 180 degrees open position, the longitudinal axis of the link 114 is disposed at an angle to a longitudinal axis extending along the side of the housing 102.

With reference to the final position d of the sequence, the housings 102, 104 are disposed at an open position about 180 degrees from the closed position. The housings 102, 104 are shown aligned in a horizontal direction in the figure. The longitudinal axis of the link 114 is aligned with the horizontal orientations of the housings 102, 104.

A spacing 127 is marked between the housings 102, 104 in the open position. The spacing 127 is less than the spacing 126 (FIG. 4). The spacing 127 is measured between the opposite edges 120, 130 of the housings 102, 104. As a result of the reduced spacing 127, there is less visual disruption when both housings 102, 104 are unfolded to the 180 degrees open position for viewing. As previously stated however, other positions are within the scope of the instant examples.

The varying distances of the spaces 126, 127 are provided by changing the distance between the pivot locations of the housings 102, 104 relative to the links 114, 116. For example, as shown in FIG. 5, the pivot location of housing 102 and the housing 104 is shown as a circular broken line. The distance 128 from the center of the circular pivot location to the inner surface of the housing 102 represents a first measurement. However, a second distance 129 is measured between each edge of the housings 102, 104 and the circular pivot location. The distance between the pivot location and the edges is larger than the distance between the pivot location and the inner surfaces, and as a result, the spacing 127 is smaller than the spacing 126. The circular pivot locations shown in broken line are schematically representative of the shafts 146, 148 (FIG. 6) and also shown in FIG. 3 near links 114.

Referring now to FIG. 6, a section view of an example electronic device and hinge assembly is provided. The housings 102, 104 are shown in an open position with the section cut taken to show various components of the hinge assembly 110. Each of the housings comprises a hinge bracket 140, 142. The hinge brackets 140, 142 are connected to the housings 102, 104 and provide a mounting position for hinge shafts 146, 148. The hinge brackets 140, 142 may receive a hinge shaft 146, 148. The shafts 146, 148 are arranged in parallel as are the receiving knuckles of the hinge brackets 140, 142.

The hinge assembly 110 may also comprise a torque element 150 to add frictional force to the movement of one or both of the housings 102, 104. The torque element 150 may be defined by frictional rings, torsion biasing elements, or other structures, without limitation, which may control the motion of one housing 102, or the other housing 104, or both. The hinge brackets 140, 142 may include a two part joint where one part is a knuckle which allows rotational movement of the second part, the shafts 146, 148. The knuckle joint may, in some examples, limit the motion at the joint to rotation about the shaft 146, 148 axis.

The gear assembly 160 is also shown extending between the first housing 102 and the second housing 104. The gear assembly 160 provides operable communication between the hinge shaft 146 and opposed shaft 148. The gear assembly 160 also allows this communication between the shafts 146, 148 while also providing for the spacing desired between the two housings 102, 104 in the closed position.

The gear assembly 160 comprises a plurality of gears and in the depicted version for example, there may be four gears 162, 163, 164, 165. The gears 162-165 are positioned within the link 114. The shafts 146, 148 may extend through a sidewall of the links 114, to reach gears 162, 165 inside.

Also shown in the depicted view, the link 116 is disposed adjacent to the link 114 and on the opposite side of the hinge brackets 140, 142. The link 116 may be hollow or at least partially hollow for passage of conduit(s) of power, controls and/or communication between the housings 102, 104.

The depicted view also shows an example of the housing gaps 122. These cut out areas of the housings 102, 104 allow for positioning of the links into the housings 102, 104. The housings gaps 122 are also positioned adjacent to the areas of the housings 102, 104 having the hinge brackets 140, 142 for engagement with the shafts extending therefrom.

In operation, the housing 102 may be rotated relative to the housing 104 for example. The shaft 146 may rotate within the fixed hinge bracket 140 and with the rotation of shaft 146, the gears 162-165 may rotate. The shaft 148 may also be driven by the gear rotation. Further, the shaft 146 may also translate about the shaft 148 with the rotational movement of the gears 162-165 and the shafts 146, 148.

The foregoing description of examples has been presented for purposes of illustration. It is not intended to be exhaustive or to limit the present disclosure to the precise structures and/or forms disclosed, and obviously many modifications and variations are possible in light of the above teaching. It is intended that the scope of the present disclosure and all equivalents be defined by the claims appended hereto.

1. An electronic device, comprising:
a first housing having a first display therein;
a second housing positioned adjacent to the first housing, and having a second display therein;
a hinge assembly connecting the first housing and the second housing comprising:
a link extending between the first housing and the second housing;
a first shaft disposed in the first housing;
a second shaft disposed in the second housing;
a gear assembly disposed in the link having a first gear connected to the first shaft and a second gear connected to the second shaft;
wherein a first distance is defined in a direction of the link between a first surface of the first housing and a second surface of the second housing when the first housing and the second housing are in a first configuration;
wherein a second distance is defined in a direction of the link between the first housing and the second housing when the first housing and the second housing are in a second configuration; and,
wherein the first distance is larger than the second distance.

2. The electronic device of claim 1 comprising the link pivotally engaging the first shaft and the second shaft.

3. The electronic device of claim 1 comprising a first torque element engaging the first shaft and a second torque element engaging the second shaft.

4. An electronic device, comprising:
a first housing having a first hinge shaft therein;
a second housing adjacent to the first housing;
the second housing movable through more than ninety (90) degrees relative to the first housing, the second housing having a second hinge shaft therein;
a gear assembly extending between the first hinge shaft and the second hinge shaft;
a link having the gear assembly disposed therein, wherein the housings are to pivot relative to the link and drive gear rotation;
a first distance defined between the first housing and the second housing when the link is disposed substantially perpendicular to inwardly facing surfaces of the first and second housings;
a second distance defined between the first housing and the second housing when the link is aligned with edges of the first housing;
wherein the second distance is smaller than the first distance.

5. The electronic device of claim 4, comprising a first hinge bracket connected to the first housing, and a second hinge bracket connected to the second housing.

6. The electronic device of claim 5, comprising the first hinge shaft extending from the first hinge bracket and the second hinge shaft extending from the second hinge bracket.

7. The electronic device of claim 6, wherein the first and second hinge brackets further comprise a torque element disposed at an interface of the hinge brackets and the hinge shafts, respectively.

8. The electronic device of claim 4 wherein the link is to receive the first hinge shaft and the second hinge shaft.

9. The electronic device of claim 8 comprising a second link which is hollow to route a conductor that extends between the first housing and the second housing.

10. The electronic device of claim 4, wherein one of the first housing and the second housing comprises a display and the other of the first and second housings comprises one of a system or keyboard

11. The electronic device of claim 4, wherein first housing and second housing both comprise displays.

12. The electronic device of claim 4, wherein one of the first hinge shaft is closer to a surface of the first or second housing than an edge of the first or second housing.

13. The electronic device of claim 12, wherein a geometry of the first hinge shaft relative to the surface and the edge minimizes a second distance between the first housing and the second housing in an open position.

14. An electronic device, comprising:
a first housing having a first display;
a second housing having a second display;
a link extending between the first housing and the second housing, the link to receive a first shaft in the first housing and a second shaft in the second housing;
wherein the first housing is to pivot relative to the link and the second housing is to pivot relative to the link; and
a gear assembly disposed in the link having a first gear connected to the first shaft and a second gear connected to the second shaft;
wherein the first shaft is to rotate and translate relative to the second shaft during a movement of the first housing, the second housing, or a combination thereof;
wherein the first housing and the second housing are to define a first distance when the first housing and the second housing are in a closed configuration, and wherein the first housing and the second housing are to define a second distance that is smaller than the first distance when the first housing and the second housing are in an open configuration.

15. The electronic device of claim 14, comprising a first hinge bracket receiving the first shaft and a second hinge bracket receiving the second bracket.
